(19) United States
(12) Patent Application Publication
(10) Pub. No.: US 2008/0312897 A1
(43) Pub. Date: Dec. 18, 2008

(54) Programmable Device and Method of Previewing User-Programmed Events of Programmable Devices

(75) Inventor: Nicolaas Petrus Bracke, Heeze (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/814,007

(22) PCT Filed: Jan. 13, 2006
(86) PCT No.: PCT/IB06/50124

§ 371 Date: Jul. 16, 2007

(30) Foreign Application Priority Data
Jan. 17, 2005 (EP) 05100241.8

(51) Int. Cl. G06G 7/62

(52) U.S. Cl. 703/17

(57) ABSTRACT

A programmable device (1) comprises at least one timer (8) and a memory (7) for storing a user-programmable timer list with events (EV1, EV2) triggered by the elapsing of the at least one timer (8). The programmable device (1) is adapted to be operated in a simulation mode that can be activated by the user, in which simulation mode the operation of processing the user-programmed events (EV1, EV2) stored in the timer list is simulated as if the timers (8) triggering said events had elapsed.

### FIELD OF THE INVENTION

The invention relates to a method of previewing user-programmed events of programmable devices, which events are stored in a timer list and are triggered when the times or the periods of time set by the timers have elapsed.

The invention also relates to a programmable device.

### BACKGROUND OF THE INVENTION

Programmable devices such as DVD recorders offer some functionality to make programming of timer recordings easier. Examples of such a known functionality of programmable devices are “Showview” (also known as “VCRPlus”), wherein a coded number containing the broadcasting channel, the date, time of beginning and duration of a specific TV program is input into and decoded by the programmable device, and a built-in Electronic Program Guide (EPG). An interactive television system is known from the document US 2004/0103434 A1, which system comprises an interactive television application to establish time-based settings. The user may set television program reminders, advance-order pay-per-view programs, schedule programs for recording, and establish parental controls to prevent television viewing during certain hours on certain channels. Due to the multiple setting options, conflicts may arise, especially between the recorder timer settings and the requested video delivery. The known interactive television application provides the user with on-screen options, which, during the programming phase, allow the user to select how to resolve these conflicts.

The known programmable devices, however, have proved the disadvantage of leaving the user in a state of uncertainty whether he has programmed the device correctly or not. The degree of uncertainty rises with the number of setting options available for the known devices. For instance, in the interactive television system disclosed in the document US 2004/0103434 A1, there is still a wide range of possible settings that will result in failure of recordings, even if no conflict is detected among various recorder timer settings. Hence, the user will feel insecure about his programming.

### OBJECT AND SUMMARY OF THE INVENTION

It is an object of the invention to provide a method of the type defined in the opening paragraph and a programmable device of the type defined in the second paragraph, in which the disadvantages defined above are avoided.

In order to achieve the object defined above, a method of previewing user-programmed events of programmable devices according to the invention has such characteristic features that it can be characterized in the way defined below, namely:

A method of previewing user-programmed events of programmable devices, which events are stored in a timer list and are triggered by the elapsing of timers, wherein the method comprises, at the request of a user, the step of simulating the operation of processing the stored user-programmed events as if the times or the periods of time set by the timers triggering said events had elapsed.

In order to achieve the object defined above, a programmable device according to the invention has such characteristic features that it can be characterized in the way defined below, namely:

A programmable device comprising at least one timer and a memory for storing a timer list which is user-programmable with events triggered when the time or the period of time set by the at least one timer has elapsed, wherein the programmable device is adapted to be operated in a simulation mode that can be activated by the user, in which simulation mode the operation of processing the user-programmed events stored in the timer list is simulated as if the times or the periods of time set by the timers triggering said events had elapsed.

In general, the programmable device according to the invention comprises all devices that are programmable as regards time-triggered events. The invention is particularly applicable to DVD recorders, video recorders, audio recorders and the like. It should be noted that the inventive programmable device can be configured as a stand-alone device, or can be incorporated into combined devices such as home cinema applications.

The characteristic features according to the invention provide the advantage that they enable a user to check and confirm that the events he has programmed will work correctly in the programmable device. With this positive feedback by the inventive method and programmable device, the user gains certainty about the correctness of his timer programming (or will make the necessary changes), and with this sense of confidence he will have no inhibition threshold to make use of all the programming functions offered by the programmable device.

The measures as defined in claims 2 and 9 provide the advantage that the inventive simulation does not inevitably start with the first event in the timer list, but the user may set an entry point to monitor certain events that he is particularly interested in.

The measures as defined in claims 3 and 10 provide the advantage that the whole simulation is carried out in real-time so that the user really “sees what he gets”.

The measures as defined in claims 4 and 11 provide the advantage that the simulation takes place in fast motion, so that multiple events with long time intervals between them can be checked in one run-through without the annoyance for the user to watch the programmable device for a long time.

In the course of simulating the operation of processing the user-programmed events, the actions defined by these events may be actually carried out in the programmable device, e.g. the programmable device will be switched to a certain broadcasting channel. However, it may be undesirable that each and every action is carried out, such as actually starting recording actions, or that each and every action is carried out in its entire duration. The measures as defined in claims 5 and 12 provide the advantage that the simulation process can be considerably accelerated, either by only carrying out selected actions in the programmable device, while other actions will be suppressed or replaced by visible information etc., or by limiting pre-defined actions within the events to a pre-defined or user-defined duration, or by aborting said actions by user instruction.

The measures as defined in claims 6 and 13 provide the advantage that the user receives still better and more comprehensive feedback about his programming of events of the programmable device.

When a user programs the time-triggered events erroneously, resulting in conflicts among various events or among events and other settings of the device, the measures as defined in claims 7 and 14 provide the advantage that the user will be provided with suggestions on how to resolve these conflicts. Guided by these suggestions, it is easy for the user to make necessary amendments to his programming so that the conflicts are resolved.

It should be noted that the features of the inventive method could be directly implemented in the device.

These and other aspects of the invention are apparent from and will be elucidated with reference to the non-limiting embodiments described hereinafter.

### BRIEF DESCRIPTION OF THE DRAWING

FIG. 1 shows a programmable device according to the invention in a schematic block diagram.

### DESCRIPTION OF EMBODIMENTS

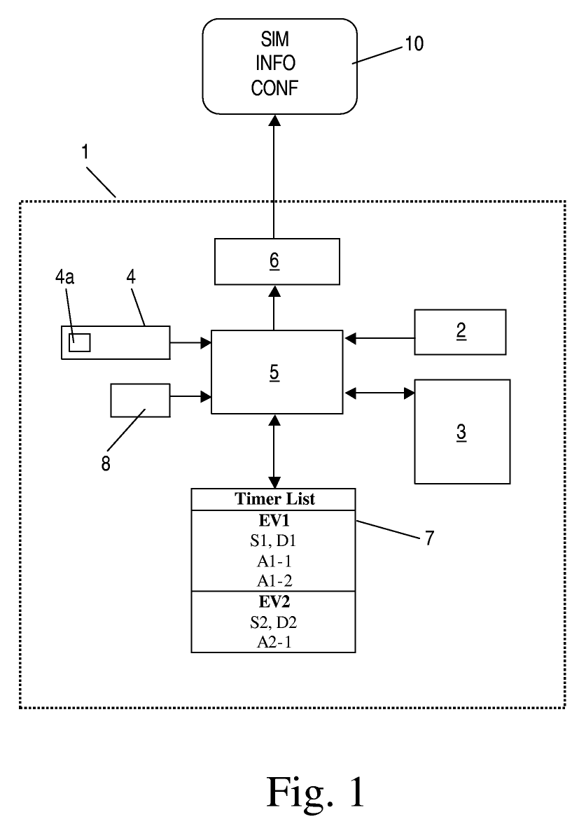

An embodiment of a programmable device 1 according to the invention is shown in FIG. 1. This embodiment may be configured as a DVD recorder, but it should be noted that the invention is generally applicable to any time-based programmable device. The programmable device 1 comprises an input section 2 for receiving audio/video data streams. It also comprises a DVD drive apparatus 3 configured to receive a DVD for recording audio/video data on and playing audio/video data from the DVD. The DVD drive apparatus 3 per se is well known to those skilled in the art, and therefore needs no extensive explanation or detailed depiction in the drawing. It will particularly be appreciated that, for the sake of clarity, conventional parts of the DVD drive apparatus such as scanning means for the disk, or driving means for the scanning means, comprising motors, coils and electronic circuits are not shown in the drawing, because they are not directly related to the invention.

The programmable device 1 further comprises input means 4, such as a keypad, to enable a user to interact with the programmable device 1. A main controller 5 controls all functions of the programmable device 1. The main controller 5 cooperates with video/audio output means 6 for outputting video/audio data from the DVD as video/audio output signals to a TV set 10 or the like. The main controller 5 is also configured to output information to the user as video signals to the TV set 10 via the video/audio output means 6, as will be described in detail hereinafter. Furthermore, main controller 5 cooperates with a memory 7 in which a timer list is stored which comprises time-triggered events EV1, EV2, etc. The time-triggered events EV1, EV2 have been programmed by a user via the input means 4 and contain starting times and dates S1, S2 which define when the events EV1, EV2 have to be triggered, as well as one or more actions A1-1, A1-2; A2-1 to be carried out by the programmable device 1 when the respective event EV1, EV2 is triggered. Optionally, the starting times and dates S1, S2 are associated with the durations D1, D2 of the respective event. The main controller 5 cooperates with a timer 8 and checks periodically whether starting times and dates S1, S2 have been reached, in order to trigger the event EV1, EV2 linked with the respective starting time and date that has been reached. In this way, multiple software timers are implemented wherein the lapse of times or periods or time set by these software timers triggers the associated events.

Some examples of how to program the present programmable device 1 will now be given. A user may wish to record two programs, e.g. program P1 at a particular date from 13:00 to 14:00 hrs and program P2 at the same date from 14:00 to 17:00 hrs. DVD recorders provide recording in several quality modes, which are M1 (1 hour for high quality), M2 (2 hours medium quality) and M3 (3 hours low quality). Programming a DVD recorder typically involves selecting the desired quality mode. In addition, the channel and the duration of the recording must be set and the user must indicate that he wishes to make use of the PDC (=program delivery control), also known as VPS (=video programming signal). In order to accomplish all the programming steps, the user gives the necessary inputs via input means 4, and the main controller 5 of the programmable device 1 builds the associated timer list in the memory 7. The programmable device 1 hitherto described is operated in a conventional mode. As will be recognized, such a time-based programmable device 1 can be tricky and may have snags for an inexperienced user. Even though programming has become easier by providing e.g. PDC, users not familiar with these types of devices often feel uncertain whether they have programmed their devices in a correct way. For example, the user may select PDC but the programmed channel does not contain PDC. The user may also set M1 and adjust the timer for a 3-hour recording.

The present invention solves this problem by providing a programming simulation function for the time-based programmable device 1. According to the invention, the main controller 5 of the programmable device 1 can be switched to a simulation mode in which the operation of processing the user-programmed events EV1, EV2 stored in the timer list is simulated as if the timers triggering said events had elapsed. This simulation mode offers a preview of the programmed time-triggered events EV1, EV2, so that, when activated after programming, the user can test his program settings and, during simulation, receives appropriate feedback from the programmable device 1 whether all settings are reliable or whether there is a conflict between what the user desires, which is expressed in terms of settings provided during programming, and the real device activity at the start of the programmed recordings.

There is such a conflict when the user has programmed three hours of recording program P2, namely from 14:00 to 17:00 hrs in the above example, and has chosen the M1 quality mode for the same recording. There is also such a conflict when the user has selected a channel, which does not comprise the PDC signal, and has activated the PDC feature. In both situations, the reaction of the programmable device can be simulated/estimated during the programming simulation mode and the user can additionally be informed about corrections, which are necessary in order to have the programmable device 1 act according to what he expects or in accordance with external restraints. Switching the main control 5 to the simulation mode is accomplished by a preview button 4a of the input means 4. By pressing the preview button 4a once more, the programmable device 1 will be switched back to the normal operation mode.

In the simulation mode, the whole timer list is usually processed, starting from the first event EV1 in the timer list. However, sometimes the user might be interested to check only a part of his programming. In such a case, the invention provides the possibility of pre-selecting an event of the timer list, from which the simulation must start. An event of the timer list as a starting point for simulation can be pre-selected by means of the input means 4.

Simulating the operation of processing the user-programmed events EV1, EV2 stored in the timer list is generally carried out in real-time. This offers the opportunity to find problematic time programming of events. For instance, in the above example, program P1 is recorded from 13:00 to 14:00 hrs. Immediately after having completed recording of program P1 at 14:00 hrs, recording of program P2 has to be started at the same time. While in theory such a programming does not cause any conflict, problems can nevertheless arise in practice, for instance, when there is a delay in switching between the two program recordings P1, P2 caused by the programmable device 1. When the user has activated the simulation mode of the programmable device 1, he can easily detect this conflict of recordings caused by the delay.

In the strict, real-time simulation mode, the actions A1-1, A1-2, A2-1 of the events EV1, EV2 are carried out in the correct time sequence and with the correct time intervals between them. However, in some cases, the user might wish to accelerate the simulation process. Therefore, the invention offers some possibilities to change the simulation mode from real-time to “fast-motion” with accelerated processing of the events to be simulated. In one embodiment of the invention, the user can jump to the next phase of the simulation (e.g. stop the operation of simulating the recording, with the programmable device 1 acting as if the recording was finished) by pressing a “next”-button on the input means 4. In another embodiment of the invention, specific actions, such as simulated recordings, are limited to a predefined or user-settable time (for example, 20 seconds).

Another embodiment of the programmable device 1 provides the feature of pre-defining or user defining, respectively, those actions that can (or must) actually be carried out in the simulation mode and those that must be excluded from being actually carried out in this mode. Those actions that are excluded from actually being processed in the simulation mode can simply be suppressed during simulation, or can be replaced by other actions, such as showing information INFO on the TV set 10 connected to the programmable device 1.

What is really of interest to the user in the simulation mode of the programmable device 1 is the real-time behavior of the device 1 at transitions from one event EV1 to the next event EV2. Therefore, in the course of simulating the operation of processing the user-programmed events EV1, EV2, it might be necessary to actually carry out actions A1-1, A1-2, A2-1 defined by these events. For instance, it is necessary to actually switch to a specified TV channel in order to check whether this TV channel provides VPS signals. Or, turning back to the above example: after recording of the first program P1 (first event EV1), the programmable device 1 configured as a DVD recorder can go to the standby mode before the next event EV2 (recording of program P2) is handled. When these two events are programmed contiguously, the DVD recorder needs some time to start with the second event EV2, because a DVD recorder coming out of its standby mode needs to read the DVD first so as to see where to start the next recording. This startup time could be the cause of missing the beginning of recording the next program P2. In the simulation mode, this could be shown to the user. He could then decide to shorten the duration of the first event so as to ensure that the second event is started in time.

In order to keep the user comprehensively informed about the progress of the simulation, main controller 5 writes information SIM via the video output means 6 to the TV set 10 when the programmable device 1 is switched to the simulation mode. Furthermore, each action of each event, which is in the process of being simulated, is reported to the TV set 10. The user is thus always well informed about the current status of the programmable device 1. Moreover, conflict checks are carried out in the simulation mode and conflict information CONF is shown to the user, optionally together with proposals for resolving the detected conflicts. Examples of conflicts have already been explained above.

It should be noted that the information provided by the inventive programmable device is not necessarily written to a TV set, but can alternatively be shown on a display of the programmable device 1. Furthermore, the present programmable device 1 is not limited to devices that need to be connected to TV sets.

1. A method of previewing user-programmed events (EV1, EV2) of programmable devices, which events (EV1, EV2) are stored in a timer list and are triggered by the elapsing of timers, wherein the method comprises, at the request of a user, the step of simulating the operation of processing the stored user-programmed events (EV1, EV2) as if the timers (8) triggering said events had elapsed.

2. A method as claimed in claim 1, wherein simulation of the operation of processing the stored user-programmed events (EV1, EV2) is started from a pre-selected event (EV2) in the timer list.

3. A method as claimed in claim 1, wherein the operation of processing the stored user-programmed events (EV1, EV2) is simulated in real-time.

4. A method as claimed in claim 1, wherein the operation of processing the stored user-programmed events (EV1, EV2) is simulated in an accelerated mode.

5. A method as claimed in claim 1, wherein simulation of the operation of processing the stored user-programmed events (EV1, EV2) comprises the step of limiting pre-defined actions within the events to a pre-defined or user-defined duration, or aborting said actions by user instruction, or excluding said actions from being simulated, optionally replacing said instructions by displaying information (INFO) to the user.

6. A method as claimed in claim 1, wherein processing information (SIM) is displayed to the user during simulation of the operation of processing the stored user-programmed events.

7. A method as claimed in claim 1, wherein conflict checks are carried out during simulation of the operation of processing the stored user-programmed events and conflicts are reported (CONF) to the user, optionally together with proposals for resolving these conflicts.

8. A programmable device (1) comprising at least one timer (8) and a memory (7) for storing a user-programmable timer list with events (EV1, EV2) triggered by the elapsing of the at least one timer (8), wherein the programmable device (1) is adapted to be operated in a simulation mode that can be activated by the user, in which simulation mode the operation of processing the user-programmed events (EV1, EV2) stored in the timer list is simulated as if the timers (8) triggering said events had elapsed.

9. A programmable device as claimed in claim 8, wherein, in the simulation mode, simulation of the operation of processing the stored user-programmed events (EV1, EV2) is started from a pre-selected event (EV2) in the timer list.

10. A programmable device as claimed in claim 8, wherein, in the simulation mode, the operation of processing the stored user-programmed events (EV1, EV2) is simulated in real-time.

11. A programmable device as claimed in claim 8, wherein, in the simulation mode, the operation of processing the stored user-programmed events (EV1, EV2) is simulated in an accelerated mode.

12. A programmable device as claimed in claim 8, wherein simulation of the operation of processing the stored user-programmed events (EV1, EV2) comprises the step of limiting pre-defined actions within the events to a pre-defined or user-defined duration, or aborting said actions by user instruction, or excluding said actions from being simulated, optionally replacing said instructions by displaying information (INFO) to the user.

13. A programmable device as claimed in claim 8, wherein processing information (SIM) is displayed to the user during simulation of the operation of processing the stored user-programmed events (EV1, EV2).

14. A programmable device as claimed in claim 8, wherein, in the simulation mode, conflict checks are carried out and conflicts are reported (CONF) to the user, optionally together with proposals for resolving these conflicts.
